(19) United States
(12) Patent Application Publication
(10) Pub. No.: US 2009/0037085 A1
(43) Pub. Date: Feb. 5, 2009

(54) Starting system and method of internal combustion engine

(75) Inventor: Susumu Kojima, Susono-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 11/918,417

(22) PCT Filed: Apr. 21, 2006
(86) PCT No.: PCT/IB2006/000959

§ 371 Date: Oct. 12, 2007

(30) Foreign Application Priority Data
Apr. 22, 2005 (JP) 2005-125333

(51) Int. Cl. F02D 45/00

(52) U.S. Cl. 701/113; 123/179.5

(57) ABSTRACT

In a starting system of an internal combustion engine including a fuel injection valve that directly injects fuel into a corresponding cylinder and a spark plug that ignites an air-fuel mixture in the cylinder, injection of the fuel from the fuel injection valve and ignition performed by the spark plug are stopped when engine stop conditions are met. If the engine restart conditions are met during rotation of the engine after the engine stop conditions are met, the fuel is injected from the fuel injection valve into an expansion-stroke cylinder that is in the expansion stroke at the time when the engine restart conditions are met, and the mixture formed in the expansion-stroke cylinder is ignited by the spark plug.

### TECHNICAL FIELD

The invention relates to starting system and method of an internal combustion engine of a motor vehicle.

### BACKGROUND ART

In recent years, a direct in-cylinder injection type spark ignition internal combustion engine has been developed which performs economical-ecological running control (hereinafter called “eco-run control”) for automatically stopping the operation of the engine during a stop of a vehicle in which the engine is installed, for example, and automatically restarting the engine when the vehicle is started again, for the purposes of reducing the fuel consumption and suppressing the amount of CO₂ emissions. Under the eco-run control, engine stop conditions are met when the vehicle is in the stopped state and the amount of depression of the accelerator pedal is equal to zero, for example. If the engine stop conditions are met, supply of fuel from fuel injection valves and ignition of air-fuel mixtures using spark plugs are stopped or inhibited. Subsequently, if engine restart conditions are met when the accelerator pedal is depressed, for example, the engine is put into operation again.

Even if the engine stop conditions are met, and the activities, such as fuel supply and ignition, of the engine are stopped or inhibited, the rotation of the engine (i.e., the rotation of the crankshaft) is not immediately stopped, but the engine or crankshaft is kept rotating under the inertial force, or the like, over a certain period of time from the meeting of the engine stop conditions. If the engine restart conditions are met during this period, the engine needs to be started again while the rotation of the engine is not completely stopped.

In a conventional system as disclosed in Japanese Laid-open Patent Publication No. 2002-147264, if engine restart conditions are met while the rotation of the engine is not completely stopped after engine stop conditions are met, the fuel is supplied to a cylinder (hereinafter referred to as “compression-stroke cylinder”) that is in the compression stroke when the engine restart conditions are met, so that the engine resumes its normal rotation or running speed at the earliest possible time after the engine restart conditions are met.

In the case where the engine is restarted by utilizing supply of fuel to the compression-stroke cylinder, as disclosed in the above-identified publication, the crankshaft is required to rotate until the crank angle goes beyond the compression top dead center for the compression-stroke cylinder in order to enable ignition of an air-fuel mixture formed in the compression-stroke cylinder. This is because, if the mixture is ignited before the crank angle goes beyond the compression top dead center for the compression-stroke cylinder, combustion/explosion may take place in the cylinder before the crank angle goes beyond the compression top dead center, resulting in reverse rotation of the engine.

In the system as disclosed in the above-identified publication, therefore, the air-fuel mixture is not ignited in the compression-stroke cylinder from the time when the engine restart conditions are met until the crank angle goes beyond the compression top dead center for the compression-stroke cylinder. Thus, it takes a long time from the time when the engine restart conditions are met to the time when explosion actually takes place in the compression-stroke cylinder. Furthermore, if the engine speed is low, namely, the inertial force due to the rotation of the engine is small when the engine restart conditions are met, the engine may be stopped before the crank angle goes beyond the compression top dead center for the compression-stroke cylinder, and is thus not able to cause the mixture to burn or explode in the compression-stroke cylinder even with the fuel having been supplied to the same cylinder.

### DISCLOSURE OF INVENTION

It is therefore an object of the invention to provide starting system and method of an internal combustion engine, which make it possible to restart the engine with improved reliability at the earliest possible time after engine restart conditions are met.

To accomplish the above and/or other object(s), there is provided according to one aspect of the invention a starting system of an internal combustion engine including a fuel injection valve that directly injects a fuel into a cylinder and a spark plug that ignites an air-fuel mixture in the cylinder, the starting system being adapted to stop injection of the fuel from the fuel injection valve and ignition performed by the spark plug when an engine stop condition is met. In the starting system, when engine restart condition is met during rotation of the engine after the engine stop condition is met, the fuel is injected from the fuel injection valve into an expansion-stroke cylinder that is in an expansion stroke at the time when the engine restart condition is met, and the air-fuel mixture formed in the expansion-stroke cylinder is ignited by the spark plug.

According to the above aspect of the invention, the fuel injection and the ignition are performed in the expansion-stroke cylinder when the engine restart condition is met, so that the air-fuel mixture formed in the expansion-stroke cylinder is caused to burn or explode during the expansion stroke. Owing to the combustion/explosion of the mixture, the driving force is applied to the engine immediately after the engine restart condition is met, so that the engine can be restarted with improved reliability at the earliest possible time after the engine restart condition is met.

In the starting system according to the above aspect of the invention, even when the engine restart condition is met during rotation of the engine after the engine stop condition is met, at least the ignition of the air-fuel mixture in the expansion-stroke cylinder may not be carried out if the engine rotates in the reverse direction at the time when the engine restart condition is met.

In the case as described above, if the engine rotates in the reverse direction at the time when the engine restart condition is met, the injection of the fuel from the fuel injection valve into the expansion-stroke cylinder, as well as the ignition of the mixture in the expansion-stroke cylinder, may be stopped or inhibited.

In the starting system of the above aspect of the invention, when the engine restart condition is met during rotation of the engine after the engine stop condition is met, the fuel may be injected during the compression stroke into a compression-stroke cylinder that is in the compression stroke at the time when the engine restart condition is met, in addition to the injection of the fuel into the expansion-stroke cylinder and the ignition of the air-fuel mixture in the expansion-stroke cylinder.

In the case as described just above, after the fuel is injected into the compression-stroke cylinder during the compression stroke, the air-fuel mixture formed in the compression-stroke cylinder may be ignited when the compression-stroke cylinder reaches the compression top dead center or after the compression-stroke cylinder passes the compression top dead center.

Even when the engine restart condition is met during rotation of the engine after the engine stop condition is met, the injection of the fuel into the expansion-stroke cylinder and the ignition of the air-fuel mixture in the expansion-stroke cylinder may not be carried out if an exhaust valve of the expansion-stroke cylinder is open at the time when the engine restart condition is met.

In the starting system of the above aspect of the invention, the fuel may be injected in normal timing into a cylinder that is in an intake stroke at the time when the engine restart condition is met and cylinders that subsequently enter the intake stroke. Also, the ignition of the air-fuel mixture may be performed in normal timing in a cylinder that is in the intake stroke at the time when the engine restart condition is met and cylinders that subsequently enter the intake stroke.

In the starting system as described above, when the engine restart condition is met during rotation of the engine after the engine stop condition is met, at least the valve-opening timing of an exhaust valve or valves of the expansion-stroke cylinder may be retarded. Also, when the engine restart condition is met during rotation of the engine after the engine stop condition is met, at least the valve-closing timing of an intake valve or valves of the compression-stroke cylinder may be retarded.

### BRIEF DESCRIPTION OF DRAWINGS

The foregoing and/or further objects, features and advantages of the invention will become more apparent from the following description of an exemplary embodiment with reference to the accompanying drawings, in which like numerals are used to represent like elements and wherein:

FIG. 1 is a view schematically showing an internal combustion engine having a starting system as an exemplary embodiment of the invention:

FIG. 2 is a schematic cross-sectional view showing each cylinder of the engine of FIG. 1;

FIG. 3 is a view showing the valve-opening timing and valve-closing timing of intake valves of the cylinder of FIG. 2;

FIG. 4 is a view illustrating the cycle, fuel injection timing and ignition timing of each of the cylinders during the normal operation of the engine of FIG. 1;

FIG. 5 is a view illustrating the fuel injection periods, ignition timing, the periods in which the intake valves are open, and the periods in which exhaust valves are open, in the case where engine restart conditions are met after engine stop conditions are met but before the engine is completely stopped;

FIG. 6 is a time chart illustrating the behavior of the engine in the case where the engine restart conditions are met after the engine stop condition are met but before the engine is completely stopped;

FIG. 7 is a time chart illustrating the behavior of the engine in a period from the time when the engine stop conditions are met to the time when the engine is completely stopped;

FIG. 8 is a graph indicating the relationship between the engine speed sensed at the time when the engine stop conditions are met, and the crank angle over which the crankshaft is able to rotate from the time of the meeting of the engine stop conditions; and

FIG. 9 is a flow chart illustrating a control routine of engine restart control performed by the starting system of the embodiment.

MODE FOR CARRYING OUT THE INVENTION

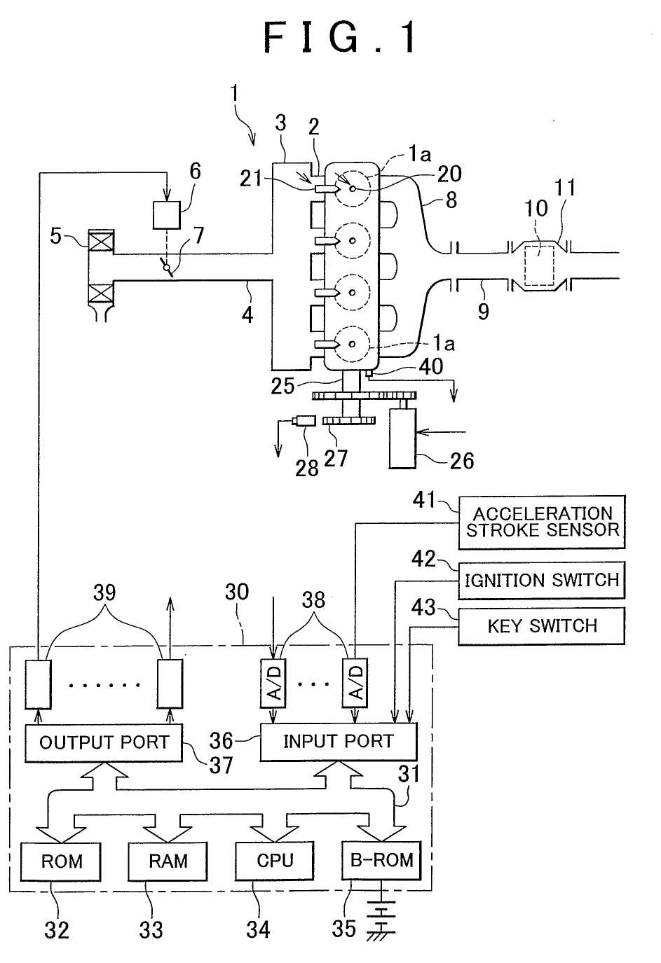

Referring to FIG. 1 illustrating an internal combustion engine having a starting system as one exemplary embodiment of the invention, an engine body 1 includes a plurality of cylinders, for example, four cylinders 1a. Each of the cylinders 1a is coupled to a surge tank 3 via a corresponding intake branch pipe 2, and the surge tank 3 is coupled to an air cleaner 5 via an intake duct 4. A throttle valve 7 adapted to be driven by an actuator 6 is disposed in the intake duct 4. Each of the cylinders 1a is also coupled to a catalytic converter 11 that contains a catalyst 10 for treating exhaust gas, via an exhaust manifold 8 and an exhaust pipe 9. In the internal combustion engine shown in FIG. 1, combustion successively takes place in the cylinders 1a in the order of #1, #3, #4, and #2.

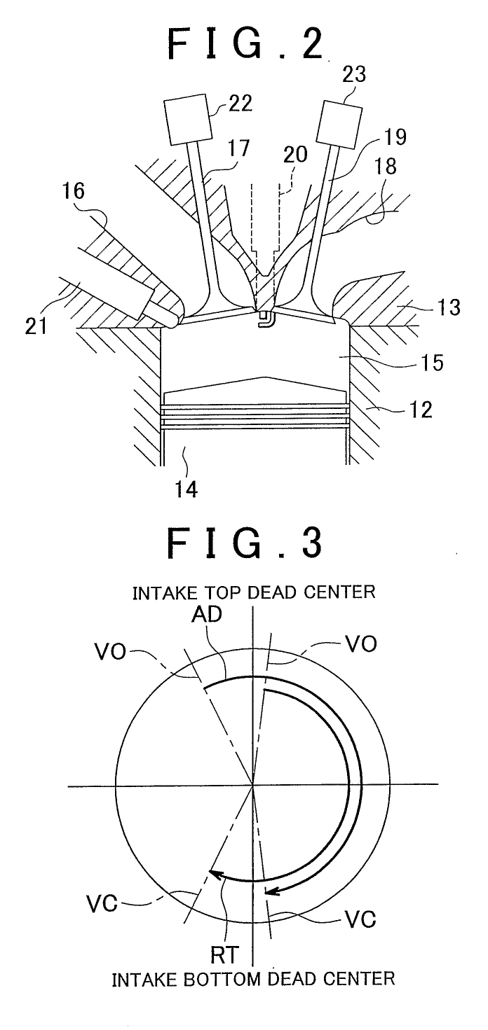

Referring to FIG. 2 showing each of the cylinders 1a in greater detail, reference numeral 12 denotes a cylinder block, and reference numeral 13 denotes a cylinder head fixedly mounted on the cylinder block 12. A piston 14 is received in the cylinder block 12 such that the piston 14 is capable of reciprocating in the cylinder block 12, and a combustion chamber 15 is formed between the top of the piston 14 and the cylinder head 13. The cylinder head 13 is formed or provided with a pair of intake ports 16, a pair of intake valves 17, a pair of exhaust ports 18 and a pair of exhaust valves 19. A spark plug 20 is located in a central portion of the inner wall of the cylinder head 13, and a fuel injection valve 21 is located in a peripheral portion of the inner wall of the cylinder head 13.

The intake valves 17 of each cylinder 1a are driven, i.e., are opened and closed by an intake-valve drive device 22. The intake-valve drive device 22 includes a camshaft, and a switching mechanism for selectively switching the angle of rotation of the camshaft relative to the crank angle between the advance side and the retard side. If the angle of rotation of the camshaft is advanced, the valve-opening timing (the moment at which the valve opens) VO and valve-closing timing (the moment at which the valve closes) VC of the intake valves 17 are advanced, as indicated by arrow AD in FIG. 3, relative to the intake top dead center and intake bottom dead center of the piston. If the angle of rotation of the camshaft is retarded, the valve-opening timing VO and valve-closing timing VC of the intake valves 17 are retarded, as indicated by arrow RT in FIG. 3. In these cases, the phase angle (the timing of opening and closing of the valves) is changed while the lift and operation angle (the valve opening period) of the intake valves 17 are kept unchanged. In the internal combustion engine shown in FIG. 1, the angle of rotation of the camshaft is switched to the advance side or the retard side, depending upon the engine operating state. The invention is also applicable to the case where the valve-opening timing of the intake valves 17 can be continuously changed, or the case where the lift and/or operation angle can be changed.

The exhaust valves 19 of each cylinder are driven, i.e., are opened and closed by an exhaust-valve drive device 23. Like the intake-valve drive device 22 as described above, the exhaust-valve drive device 23 includes a camshaft and a switching mechanism, and is operable to change the phase angle of the exhaust valves 19.

Referring again to FIG. 1, an electric motor 26 may be coupled to a crankshaft 25 via a clutch (not shown). The electric motor 26 may be provided by, for example, a starter motor, or may be provided by an electric motor having a power generating function, namely, an electric motor that is driven/rotated by the crankshaft 25 so as to generate electric power.

A rotor 27 is fixed on the crankshaft 25, and includes, for example, 35 teeth or projections formed at spacings of 10° with one tooth missing, for example. A crank angle sensor 28 comprising an electromagnetic pick-up is located so as to face the projections of the rotor 27. The crank angle sensor 28 produces an output pulse each time one of the projections of the rotor 27 passes the crank angle sensor 28. The rotor 27 is formed with a tooth-missing portion at which a tooth would be placed if the teeth or projections were regularly formed at spacings of 10°, such that the piston of, for example, #1 cylinder is at the top dead center when the tooth-missing portion faces the crank angle sensor 28. When a signal indicative of the tooth-missing portion is detected, it is to be understood that the crank angle is equal to 0° CA. In this manner, the crank angle can be determined on the basis of the output pulses successively produced by the rotor 27. Also, the engine speed can be determined from the length of time it takes from a point of time at which the signal indicative of the tooth-missing portion is produced to a point of time at which the same signal is produced next time, namely, the time it takes for the crankshaft 25 to make one rotation or rotate by 360°.

An electronic control unit (ECU) 30 consists of a digital computer, and includes ROM (read only memory) 32, RAM (random access memory) 33, CPU (microprocessor) 34, B-RAM (backup RAM) 35 that is connected to a power supply all the time, an input port 36 and an output port 37, which are connected to one another by a bidirectional bus 31.

A water temperature sensor 40 that produces an output voltage indicating an engine coolant temperature is attached to the engine body 1. An acceleration stroke sensor 41 that produces an output voltage indicating an amount of depression of an accelerator pedal (not shown) is attached to the accelerator pedal. The output signals of these sensors 40, 41 are respectively transmitted to the input port 36 via corresponding A/D converters 38. To the input port 36 are also connected the above-indicated crank angle sensor 28, an ignition (IG) switch 42 that produces an output pulse indicating that the switch 42 is placed in the ON state, and a key switch 43 that produces an output pulse indicating that the switch 43 is placed in the ON state. The ignition switch 42 and the key switch 43 are manually operated by the driver of the vehicle in which the engine is installed. On the other hand, the output port 37 is connected to the actuator 6, fuel injection valves 21, spark plugs 20 and the electric motor 26 via corresponding drive circuits 39.

The internal combustion engine of the present embodiment is operable at normal times in a selected one of two operating modes, i.e., a homogeneous (or uniform charge) combustion mode and a stratified charge combustion mode. In the homogeneous combustion mode, fuel is injected into the combustion chamber 15 during the intake stroke, and the air-fuel mixture is ignited after the air-fuel ratio of the mixture is made substantially uniform in the entire volume of the combustion chamber 15. In the stratified charge combustion mode, fuel is injected during the compression stroke immediately before the ignition, and the mixture is ignited in a condition in which the fuel is locally present only in the vicinity of the spark plug. The operating mode is selected from these two combustion modes on the basis of the engine load and the engine speed. For example, the engine operates in the stratified charge combustion mode in an operating region in which the engine load is small and the engine speed is low, and operates in the homogeneous combustion mode in an operating region in which the engine load is large and the engine speed is high.

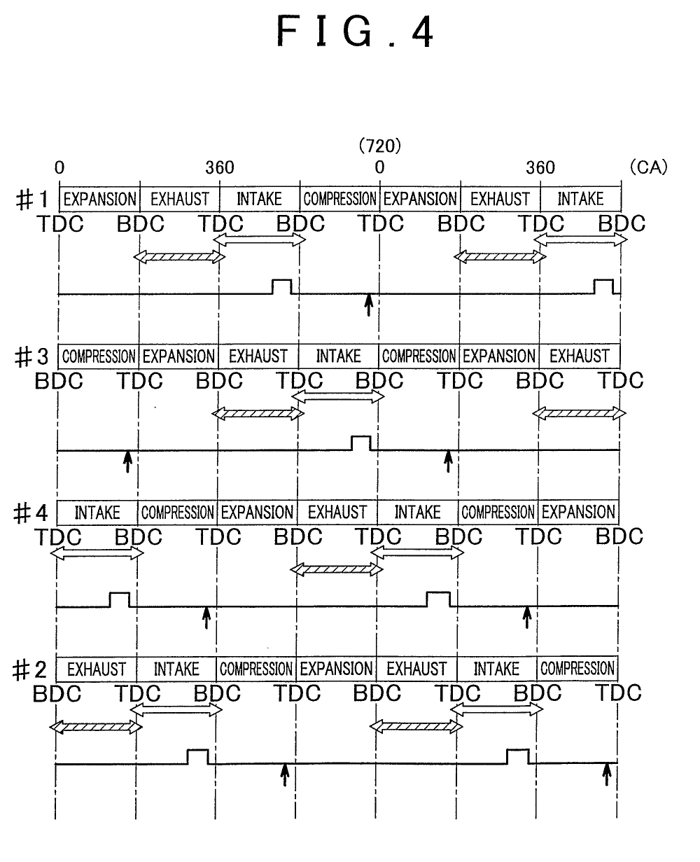

FIG. 4 shows the valve-opening and valve-closing timings of the intake valves 17, the valve-opening and valve-closing timings of the exhaust valves 19, the fuel injection timing and ignition timing of each cylinder, with respect to the crank angle θ, when the engine operates at normal times in the homogeneous combustion mode. In particular, FIG. 4 shows the valve-opening and valve-closing timings (indicated by white arrows) of the intake valves 17, the valve-opening and valve-closing timings (indicated by hatched arrows) of the exhaust valves 19, the fuel injection period and the ignition timing (indicated by black arrows), with respect to changes in the crank angle θ in the case where θ is equal to 0° CA when the piston of #1 cylinder is at the top dead center of the compression stroke.

As shown in FIG. 4, when the engine is in a normal operating state (namely, when the engine is not in a stopped state under eco-run control which will be described later), each cylinder repeatedly goes through the intake stroke, compression stroke, expansion stroke and the exhaust stroke in accordance with rotation of the crankshaft 25. Described more specifically with regard to #4 cylinder, for example, the intake valves 17 are opened during the intake stroke and immediately before and after the same stroke so that air is inducted into the cylinder in the intake stroke. In the embodiment shown in FIG. 4, the fuel is injected from fuel injection valve 21 during the intake stroke, so that the air-fuel mixture is formed in the cylinder in the intake stroke. The mixture is then compressed in the compression stroke, and is ignited by the spark plug 20 at around the compression top dead center so that explosion of the mixture takes place. In the following expansion stroke, the piston 14 of #4 cylinder is pushed down under the force generated by the explosion. Then, the exhaust valves 19 are opened during the exhaust stroke and immediately before and after the same stroke so that exhaust gas is discharged from the cylinder in the exhaust stroke.

While the fuel is injected from the fuel injection valve 21 during the intake stroke when the engine operates in the homogeneous combustion mode as described above, the fuel is injected from the fuel injection valve 21 during the compression stroke when the engine operates in the stratified charge combustion mode.

The internal combustion engine of this embodiment is started by the electric motor 26 when the driver turns on the ignition switch 42, and the operation of the engine is stopped when the driver turns off the key switch 43.

Furthermore, the engine of this embodiment automatically stops operating if certain engine stop conditions are met, even when the key switch 43 is not placed in the OFF state by the driver. More specifically, when the engine stop conditions are met, the fuel injection from the fuel injection valve 21 and the ignition using the spark plug 20 are automatically stopped or inhibited, and the operation or rotation of the engine (i.e., the rotation of the crankshaft 25) is automatically stopped. If certain engine restart conditions are subsequently met, the engine is automatically re-started (i.e., the crankshaft 25 is rotated again). Thus, the starting system of the embodiment is adapted to perform control (hereinafter called “eco-run control”) for automatically stopping and restarting the engine under certain conditions even when the key switch is not placed in the OFF state by the driver, thereby to reduce the fuel consumption and emissions of exhaust gas.

The engine stop conditions are met, for example, when the engine load is equal to zero (namely, the amount of depression of the accelerator pedal sensed by the acceleration stroke sensor 41 is equal to zero) AND the engine speed is low, or when these two conditions are satisfied AND the speed of the vehicle on which the engine is installed is equal to zero. More specifically, the engine stop conditions are met when the vehicle is rapidly decelerated or the vehicle is stopped, for example. Thus, the ECU 30 determines whether the engine stop conditions are met, based on the outputs of, for example, the acceleration stroke sensor 41, crank angle sensor 28, vehicle speed sensor (not shown) for sensing the speed of the vehicle on which the engine is installed, brake pedal position sensor (not shown) for sensing the amount of depression of the brake pedal by the driver, and so forth.

On the other hand, the engine restart conditions are met when the engine load becomes unequal to zero, or the engine load is expected to be unequal to zero, for example. More specifically, the engine restart conditions are met, for example, when the driver depresses the accelerator pedal, or when the amount of depression of the brake pedal by the driver is reduced, or when the driver depresses a clutch pedal or changes the position of the shift lever from N (neutral) or P (parking) range to D (drive) range during a stop of the vehicle. Thus, the ECU 30 determines whether the engine restart conditions are met, on the basis of the outputs of, for example, the acceleration stroke sensor 41, vehicle speed sensor, brake pedal position sensor, clutch sensor (not shown) for sensing depression of the clutch pedal by the driver, shift position sensor (not shown), and so forth.

Generally, under the eco-run control, the fuel injection and the ignition are stopped if the engine stop conditions are met so that the rotation of the engine is completely stopped. If the engine restart conditions are subsequently met in a condition in which the rotation of the engine is completely stopped, the driving force is quickly applied from the electric motor 26 to the crankshaft 25 so that the engine is restarted and then normally operated.

However, the engine restart conditions may be met after the engine stop conditions are met and the engine stops being operated (namely, the fuel injection and the ignition are stopped) but before the engine is completely stopped (namely, while the engine is still running under an inertial force with no driving force applied thereto). In this case, too, the engine needs to be restarted immediately after the engine restart conditions are met. In this specification, “restarting of the engine” refers to the case where the engine resumes its normal rotation or running speed before the rotation of the engine is completely stopped, in addition to the case where the engine is re-started after the rotation of the engine is completely stopped.

When the engine restart conditions are met after the engine stop conditions are met but before the engine is completely stopped, the starting system of this embodiment causes the engine to be quickly restarted basically without an aid of the electric motor 26.

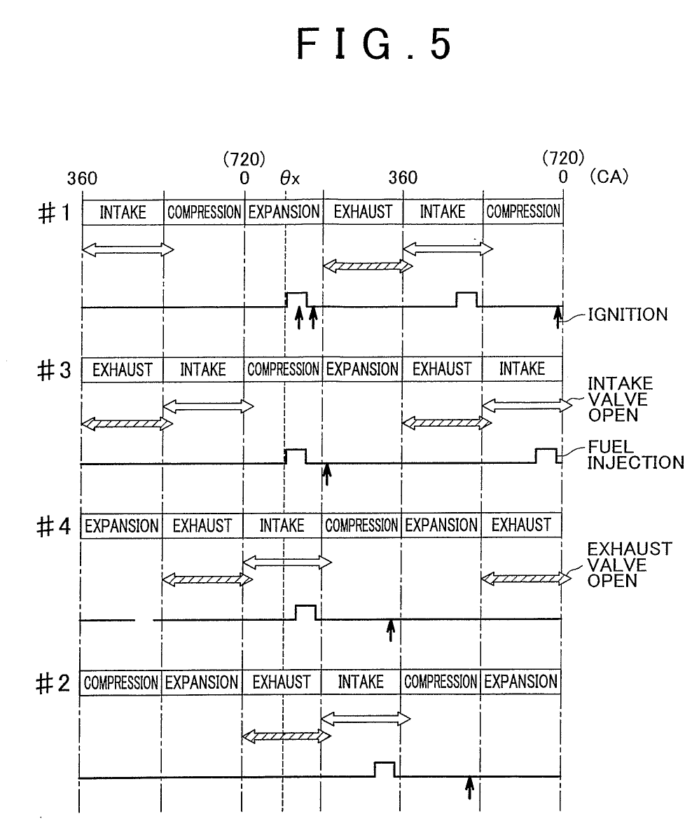

FIG. 5, which is similar to FIG. 4, shows the valve-opening and valve-closing timings of the intake valves of each cylinder and other events, with respect to the crank angle θ, in the case where the engine restart conditions are met after the meeting of the engine stop conditions but before a complete stop of the engine. In FIG. 5, time θx represents a point of time at which the engine restart conditions are met. It is thus to be understood that the fuel injection and the ignition are stopped or inhibited prior to time θx, and the engine is restarted under restart control (which will be described later) upon and after time θx.

As is understood from FIG. 5, when the engine restart conditions are met after the engine stop conditions are met but before the engine is completely stopped, the fuel is injected from the fuel injection valve 21 into the combustion chamber 15 of the cylinder (hereinafter referred to as “expansion-stroke cylinder”, e.g., #1 cylinder in the example of FIG. 5) that is in the expansion stroke at the time (denoted by θx in FIG. 5) when the engine restart conditions are met, so that an air-fuel mixture is formed in the expansion-stroke cylinder. Then, during or after the fuel injection from the fuel injection valve 21, the mixture formed in the expansion-stroke cylinder is ignited by the spark plug 20 of the expansion-stroke cylinder. In this connection, the air-fuel mixture in the expansion-stroke cylinder is less likely to be ignited at this stage since the temperature and pressure of the mixture in the expansion-stroke cylinder are lower than those of the mixture in the same cylinder which would be sensed when the crank angle is at the compression top dead center immediately before the expansion stroke. It is therefore desirable to cause the spark plug 20 to ignite the mixture two or more times. For example, the spark plug 20 may be continuously actuated to ignite the mixture during and after the fuel injection from the fuel injection valve 21.

In the manner as described above, the air-fuel mixture formed in the expansion-stroke cylinder is caused to burn or explode, thereby to push down the piston 14 of the expansion-stroke cylinder to provide the driving force of the engine, which promotes recovery of the rotation of the engine (or rotation of the crankshaft 25).

Upon a restart of the engine, the engine operates in the homogeneous combustion mode as shown in FIG. 4 so as to provide the driving force required for restarting the engine, because a suitable air-fuel mixture is unlikely to be formed if stratified charge combustion is performed. In the homogeneous combustion mode, the fuel injection is carried out during the intake stroke as described above. Where the fuel injection and ignition are similarly performed in the homogeneous combustion mode during restarting of the engine, the fuel is injected into the cylinder (hereinafter referred to as “intake-stroke cylinder”, e.g., #4 cylinder in the example of FIG. 5) that is in the intake stroke at the time when the engine restart conditions are met, and the mixture is ignited immediately before the compression top dead center for the same cylinder after the crankshaft 25 rotates 180-360° CA following the fuel injection. In order to operate the engine in the homogeneous combustion mode, therefore, it is necessary to rotate the crankshaft 25 of the engine after the engine restart conditions are met, at least until the intake-stroke cylinder (#4 cylinder in the example of FIG. 5) goes beyond the compression top dead center that comes at the end of the compression stroke.

However, even if the air-fuel mixture is caused to burn/explode in the expansion-stroke cylinder immediately after the meeting of the engine restart conditions as described above, the engine driving force obtained through the combustion/explosion is not so large, and, therefore, the crankshaft 25 may not be able to rotate until the intake-stroke cylinder goes beyond the compression top dead center.

Namely, since the volume of the combustion chamber 15 has already been increased to some extent by the time when the combustion/explosion of the mixture in the expansion-stroke cylinder takes place in the expansion stroke, the energy that can be used for pushing down the piston 14 (i.e., the energy converted into the driving force of the engine), out of the energy resulting from the combustion/explosion, is relatively small, which means that the driving force of the engine that can be obtained through the combustion/explosion is small.

In the meantime, in order to run the engine or rotate the crankshaft 25 until the intake-stroke cylinder goes beyond the compression top dead center, both the cylinder (hereinafter referred to as “compression-stroke cylinder”, e.g., #3 cylinder in FIG. 5) that is in the compression stroke when the engine restart conditions are met and the intake-stroke cylinder (#4 cylinder) are required to go beyond the respective compression top dead centers. Here, it is to be noted that air is compressed in the cylinder in the compression stroke until it reaches the compression top dead center, and the compressed air gives rise to resistance to rotation of the engine (or rotation of the crankshaft 25). Since the driving force resulting from the combustion/explosion of the mixture in the expansion-stroke cylinder is not so large as described above, the driving force alone may not overcome the resistance to the rotation of the engine which arises when the compression-stroke cylinder or intake-stroke cylinder goes beyond the compression top dead center.

In the present embodiment, therefore, when the engine restart conditions are met after the engine stop conditions are met but before the engine is completely stopped, the fuel injection and the ignition are performed in the compression-stroke cylinder (#3 cylinder in the example of FIG. 5), as well as the expansion-stroke cylinder (#1 cylinder in FIG. 5). More specifically, the fuel is injected from the fuel injection valve 21 into the combustion chamber 15 of the compression-stroke cylinder (#3 cylinder) at the time when the engine restart conditions are met or during the compression stroke following the meeting of the engine restart conditions (namely, in a period from a point of time when the engine restart conditions are met to a point of time at which the compression-stroke cylinder reaches the compression top dead center), so that an air-fuel mixture is formed in the compression-stroke cylinder. When the crank angle reaches or goes beyond the compression top dead center for the compression-stroke cylinder due to the subsequent rotation of the crankshaft 25, the mixture formed in the compression-stroke cylinder (#3 cylinder) is ignited by the spark plug 20.

As described above, in the case where the engine restart conditions are met after the engine stop conditions are met but before the engine is completely stopped, the fuel is injected into the compression-stroke cylinder as well as the expansion-stroke cylinder, and the air-fuel mixture is then ignited in the compression-stroke cylinder when or after it reaches the compression top dead center. As a result, combustion/explosion of the mixture takes place in the compression-stroke cylinder in a period between the meeting of the engine restart conditions and a point of time at which the crank angle reaches the compression top dead center for the intake-stroke cylinder, and the driving force resulting from the combustion/explosion enables the intake-stroke cylinder to go beyond the compression top dead center after the engine restart conditions are met. Thus, the fuel injection and the ignition are performed in the intake-stroke cylinder in the homogeneous combustion mode in substantially the same manner in which the engine operates at normal times. Also, the fuel injection and the ignition are performed in the cylinders that subsequently and successively enter the intake stroke in substantially the same manner in which the engine operates at normal times.

In other words, according to the present embodiment, the fuel injection and the ignition are performed in the expansion-stroke cylinder and the compression-stroke cylinder immediately after the meeting of the engine restart conditions, thereby to provide driving force large enough to restart the engine and permit the normal operation of the engine after the restart of the engine.

As described above, the fuel injection and the ignition are performed in the expansion-stroke cylinder, which leads to a significant reduction of time it takes from the meeting of the engine restart conditions to the initial occurrence of the combustion/explosion (hereinafter called “initial explosion”) of the mixture in any of the cylinders, thus making it easy to restart the engine without an aid of the electric motor 26.

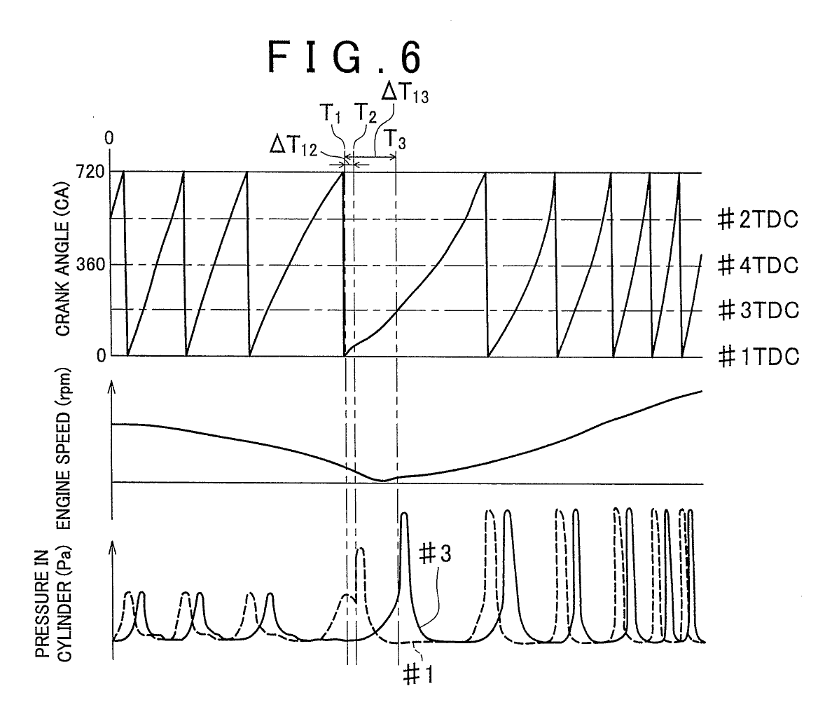

FIG. 6 is a time chart that shows the behavior of the engine from the time when the engine stop conditions are met and the fuel injection and the ignition are stopped to the time when the engine speed is raised to a certain point (the crankshaft 25 resumes its normal rotation) owing to the fuel injection and ignition performed in the expansion-stroke cylinder as described above. In FIG. 6, the upper section shows changes in the crank angle with time, and the middle section shows changes in the engine speed with time, while the upper section shows changes in the pressures within #1 cylinder (indicated by a broken line) and #3 cylinder (indicated by a solid line).

Referring to FIG. 6, if the engine stop conditions are met at time 0, the engine stops being operated, and the fuel injection from the fuel injection valve 21 and the ignition using the spark plug 20 are stopped or inhibited with respect to all of the cylinders so that no combustion/explosion of the air-fuel mixture takes place in any of the cylinders. As a result, the pressure within each of the cylinders increases only by such a degree that results from elevation of the piston 14 in the cylinder, as shown in FIG. 6. Also, since no explosion takes place in any of the cylinders, the engine speed gradually decreases due to the friction against the inertial rotation of the engine, and the crank angle that advances per unit time is reduced.

If the engine restart conditions are met at time T₁, the fuel injection and the ignition are performed in the expansion-stroke cylinder (e.g., #1 cylinder in FIG. 6), so that combustion/explosion (initial explosion) of the air-fuel mixture takes place at time T₂ in the expansion-stroke cylinder. Upon combustion/explosion of the mixture, the pressure in the expansion-stroke cylinder rapidly increases, thereby to push down the piston of the expansion-stroke cylinder. As a result, the driving force is applied to the engine, and the engine speed is increased.

Subsequently, at time T₃, the compression-stroke cylinder (e.g., #3 cylinder in FIG. 6) goes beyond the compression top dead center, and at substantially the same time the air-fuel mixture in the compression-stroke cylinder is ignited. As a result, the pressure in the compression-stroke cylinder rapidly increases at or immediately after the compression top dead center for the compression-stroke cylinder, thereby to push down the piston of the compression-stroke cylinder. With the downward movement of the piston, the driving force is applied to the engine, and the engine speed is increased.

Thus, according to the present embodiment, it takes a considerably short time (ΔT₁₂ in FIG. 6) from the meeting of the engine restart conditions to the occurrence of the initial explosion of the mixture, as shown in FIG. 6. If a conventional starting system (for example, the starting system as disclosed in Japanese Laid-open Publication No. 2002-147264) is employed which performs fuel injection and ignition in the compression-stroke cylinder without performing fuel injection and ignition in the expansion-stroke cylinder after the engine restart conditions are met, it takes a relatively long time (ΔT₁₃ in FIG. 6) from the meeting of the engine restart conditions to the initial explosion of the mixture. Thus, the starting system of this embodiment makes it possible to reduce the period of time it takes until the initial explosion takes place by one-half or more as compared with the conventional starting system as described above.

If the period of time it takes from the meeting of the engine restart conditions to the occurrence of the initial explosion is long, the rotation of the engine (or the rotation of the crankshaft 25) may be completely stopped during this period depending upon the engine speed sensed at the time of the meeting of the engine restart conditions, and an aid of an electric motor may be required to restart the engine. In this embodiment in which it takes a short time from the meeting of the engine restart conditions to the occurrence of the initial explosion, on the other hand, the initial explosion takes place before the engine is completely stopped, and, therefore, the engine can be easily restarted without an aid of the electric motor.

Generally, the exhaust valves 19 are opened in the final period of the expansion stroke, and are then closed in the initial period of the intake stroke. Namely, the exhaust valves 19 are in the open state from a certain point in the final period of the expansion stroke to the expansion bottom dead center, as well as in the exhaust stroke and the initial period of the intake stroke. In the case where the fuel injection and the ignition are performed in the expansion-stroke cylinder as described above, combustion/explosion of the air-fuel mixture takes place at some point in the expansion stroke. In order to efficiently convert the energy obtained through the combustion/explosion into the force for pushing down the piston in the expansion-stroke cylinder, therefore, it is necessary to inhibit the exhaust valves 19 from opening from the final period of the expansion stroke down to the expansion bottom dead center or shorten the valve-opening period in the final period of the expansion stroke. It is thus desirable to retard the valve-opening timing of the exhaust valves 19 when the engine is restarted.

In the present embodiment, therefore, the valve-opening timing of the exhaust valves 19 is retarded to predetermined valve-opening timing at the same time that the engine stop conditions are met and the fuel injection and the ignition are stopped, as shown in FIG. 5. More specifically, when the engine stop conditions are met, the switching mechanism of the exhaust-valve drive device 23 operates to change the phase angle of the exhaust valves 19 as a whole to a predetermined target phase angle on the retard side. Here, the predetermined valve-opening timing is the timing that comes later than the valve-opening timing of the exhaust valves 19 employed during the normal operation of the engine, and the predetermined target phase angle is a phase angle that defines the valve-opening timing of the exhaust valves 19 as the above-indicated predetermined valve-opening timing.

Generally, the intake valves 17 are opened in the final period of the exhaust stroke, and are then closed in the initial period of the compression stroke. Namely, the intake valves 17 are in the open state from the intake bottom dead center to a certain point in the initial period of the compression stroke, as well as in the final period of the exhaust stroke and in the intake stroke. In this connection, the amount of air charged in the cylinder at the time of closing of the intake valves 17 varies in accordance with the valve-closing timing of the intake valves 17 in the compression stroke. While the pressure within the cylinder becomes substantially equal to the pressure in the intake pipe (i.e., the pressure in the surge tank and the intake branch pipe) at the time of closing of the intake valves 17, the volume of the cylinder decreases and the amount of air charged in the cylinder is reduced as the valve-closing timing of the intake valves 17 is delayed or retarded.

In the meantime, as the amount of air charged in the cylinder is larger, the energy required for compressing the air charged in the cylinder becomes larger, and the resistance to the rotation of the engine is increased. It is therefore desirable to reduce the amount of air charged in the cylinder at the time of restart of the engine so as to reduce the resistance to the rotation of the engine. Namely, it is desirable to retard the valve-closing timing of the intake valves 17 when the engine is restarted.

In the present embodiment, therefore, the valve-closing timing of the intake valves 17 is retarded to predetermined valve-closing timing at the same time that the engine stop conditions are met and the fuel injection and the ignition are stopped, as shown in FIG. 5. More specifically, when the engine stop conditions are met, the switching mechanism of the intake-valve drive device 22 operates to change the phase angle of the intake valves 17 as a whole to a predetermined target phase angle on the retard side. Here, the predetermined valve-closing timing is the timing that comes later than the valve-closing timing of the intake valves 17 employed during the normal operation of the engine, and the predetermined target phase angle is a phase angle that defines the valve-closing timing of the intake valves 17 as the above-indicated predetermined valve-closing timing.

Subsequently, the valve-opening and valve-closing timings of the intake valves 17 and exhaust valves 19 are reset to the valve-opening and valve-closing timings employed during the normal operation of the engine, at the same time that or after the fuel ignition and ignition are performed in the same manner as in the normal operation of the engine.

While each of the intake-valve drive device 22 and the exhaust-valve drive device 23 has been explained as a device that includes a camshaft and a switching mechanism in the illustrated embodiment, electromagnetic drive devices for driving the intake valves 17 and the exhaust valves 19, respectively, may be employed as the valve drive devices. In this case, it is possible to retard only the valve-closing timing of the intake valves 17 without retarding the valve-opening timing thereof, and/or retard the valve-opening timing of the exhaust valves 19 without retarding the valve-closing timing thereof. In this case, in particular, the valve-opening timing of the exhaust valves 19 may be retarded with respect to at least the expansion-stroke cylinder, or the valve-closing timing of the intake valves 17 may be retarded with respect to at least the compression-stroke cylinder, while the valve-closing timings and valve-opening timings may not be retarded with respect to the rest of the cylinders.

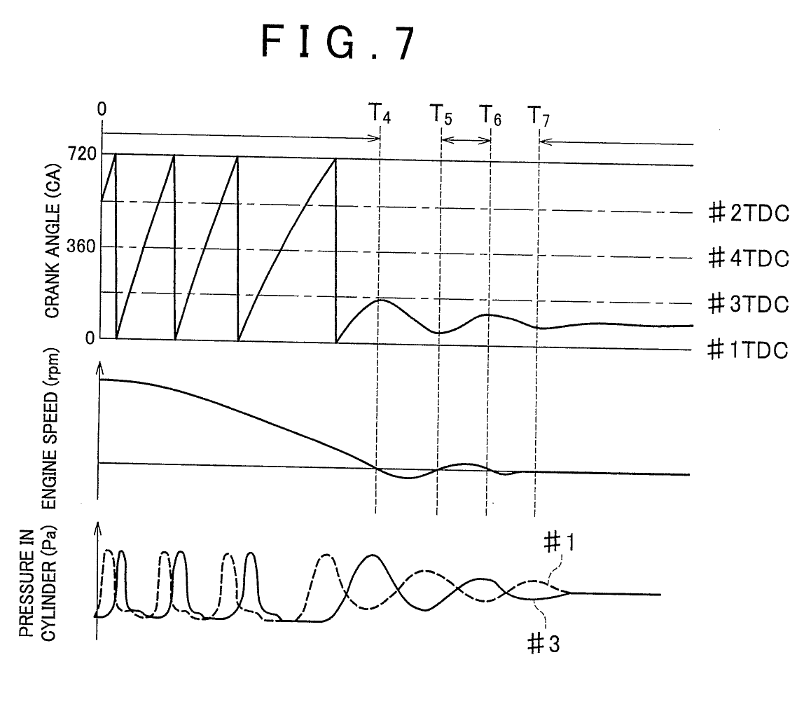

FIG. 7, which is similar to FIG. 6, is a time chart showing the behavior of the engine from the time when the engine stop conditions are met and the fuel injection and ignition are stopped to the time when the engine is completely stopped. As is understood from FIG. 7, if the engine stop conditions are met at time 0, the fuel injection and ignition are stopped with respect to all of the cylinders, and the engine speed gradually decreases due to the friction while the degree of the crank angle that advances per unit time is gradually reduced.

As the engine speed decreases, the inertial force due to the rotation of the engine decreases, and the crankshaft 25 cannot rotate until any one of the cylinders goes beyond the compression top dead center. In the example shown in FIG. 7, the crankshaft 25 cannot rotate until #3 cylinder goes beyond the compression top dead center, and the rotation of the engine is stopped at time T₄ before the crank angle reaches the compression top dead center for #3 cylinder.

At time T₄, #1 cylinder and #3 cylinder are in the expansion stroke and the compression stroke, respectively, and the intake valves 17 and the exhaust valves 19 are basically closed in both of the cylinders, while the pressure in #3 cylinder is higher than the pressure in #1 cylinder under the inertial force of the engine. In this condition, the pressure in #3 cylinder causes the piston of #3 cylinder to be pushed down, whereby the direction of rotation of the engine (or the direction of rotation of the crankshaft 25) is reversed.

With the direction of rotation of the engine thus reversed, the pressure in #1 cylinder becomes higher than the pressure in #3 cylinder, and, therefore, the engine stops rotating again (at time T₅), and then rotates again in the normal direction. After the engine repeatedly operates in this manner, the rotation of the engine is completely stopped at time T₇, and the engine is kept in the completely stopped state after time T₇.

If the engine restart conditions are met while the engine is rotating in the reverse direction, and the combustion/explosion of the air-fuel mixture takes place in the expansion-stroke cylinder (i.e., #3 cylinder in the example of FIG. 7), the engine that is rotating in the reverse direction is suddenly caused to rotate in the normal direction, resulting in a large shock given to the engine at the time of explosion. The shock given to the engine may cause problems, such as damage to the piston 14 or other member(s), and abnormal sound that arises from the engine.

In the present embodiment, even if the engine restart conditions are met, at least the ignition performed by the spark plug 20 is not carried out in the expansion-stroke cylinder while the engine is rotating in the reverse direction, namely, in the period between time T₄ and time T₅ and the period between time T₆ and T₇ in FIG. 7. With this arrangement, the combustion/explosion of the mixture is prevented during the reverse rotation of the engine.

While the spark plug 20 is inhibited from igniting the air-fuel mixture in the expansion-stroke cylinder during the reverse rotation of the engine in the illustrated embodiment, the fuel injection valve 21 may also be inhibited from injecting the fuel into the expansion-stroke cylinder during the reverse rotation of the engine.

In the above explanation, the fuel injection and the ignition are performed in the expansion-stroke cylinder in the case where the engine restart conditions are met after the engine stop conditions are met but before the engine is completely stopped. In addition to this case, the fuel injection and the ignition may also be performed in the expansion-stroke cylinder after the engine is completely stopped. In this case, too, the engine may be restarted basically by using only the driving force resulting from the fuel injection and ignition in the expansion-stroke cylinder, namely, without using the driving force available from the electric motor 26. In this case, however, the inertial force of the engine cannot be used for restarting the engine, and, therefore, the engine may not be restarted solely by using the driving force resulting from the fuel injection and ignition in the expansion-stroke cylinder, depending upon the crank angle detected at the time of complete stop of the engine. In this case, the engine is restarted by utilizing the electric motor 26, as well as the fuel injection and ignition in the expansion-stroke cylinder.

In the present embodiment, the engine is restarted through the fuel injection and ignition in the expansion-stroke cylinder in the period between time 0 and time T₄ and the period between time T₅ and time T₆ and after time T₇ in FIG. 7. If the engine rotates in the reverse direction when the engine restart conditions are met, start of control is delayed until the engine rotates in the normal direction or until the engine is completely stopped.

In the case where the fuel injection and ignition are performed in the expansion-stroke cylinder upon the meeting of the engine restart conditions, if the exhaust valves 19 are open at the time of combustion/explosion of the air-fuel mixture, combustion gas flows out of the combustion chamber 15 through the exhaust ports 18, and, therefore, the energy generated through the combustion/explosion of the mixture cannot be efficiently converted into the force for pushing down the piston 14, i.e., the driving force for running the engine.

In the present embodiment, therefore, if the exhaust valves 19 of the expansion-stroke cylinder are open when the engine restart conditions are met, or if the exhaust valves 19 are expected to be open when the combustion/explosion of the mixture takes place subsequently to the fuel injection and ignition in the expansion-stroke cylinder upon the meeting of the engine restart conditions, the fuel injection and ignition are not carried out in the expansion-stroke cylinder even if the engine restart conditions are met. With this arrangement, the fuel injection and ignition in the expansion-stroke cylinder are prevented in a situation where the energy generated through the combustion/explosion of the mixture cannot be efficiently converted into the driving force for running the engine, and otherwise possible deterioration of the fuel economy and exhaust emissions are suppressed.

When the fuel injection and the ignition are not performed in the expansion-stroke cylinder because the exhaust valves 19 of the expansion-stroke cylinder are open at the time of the meeting of the engine restart conditions, different controls are performed depending upon whether the compression-stroke cylinder can go beyond the compression top dead center after the engine restart conditions are met.

If the compression-stroke cylinder can go beyond the compression top dead center after the engine restart conditions are met, the fuel is injected from the fuel injection valve 21 into the compression-stroke cylinder, and the spark plug 20 is actuated to ignite the air-fuel mixture in the compression-stroke cylinder at the time when or immediately after the compression-stroke cylinder reaches the compression top dead center. As a result, combustion/explosion of the mixture takes place in the compression-stroke cylinder after it passes the compression top dead center, so that the engine can be restarted.

If the compression-stroke cylinder cannot go beyond the compression top dead center after the engine restart conditions are met, start of control is delayed until the exhaust valves 19 are closed or the engine is completely stopped. If the exhaust valves 19 are closed and the engine is still running after the start of control is delayed, the engine is restarted through the fuel injection and ignition in the expansion-stroke cylinder as described above. If the engine is stopped with the exhaust valves 19 left in the open state, on the other hand, the engine is restarted with an aid of the electric motor 26, since the energy generated through the explosion cannot be converted into the driving force for running the engine even if the fuel injection and ignition are performed in the expansion-stroke cylinder.

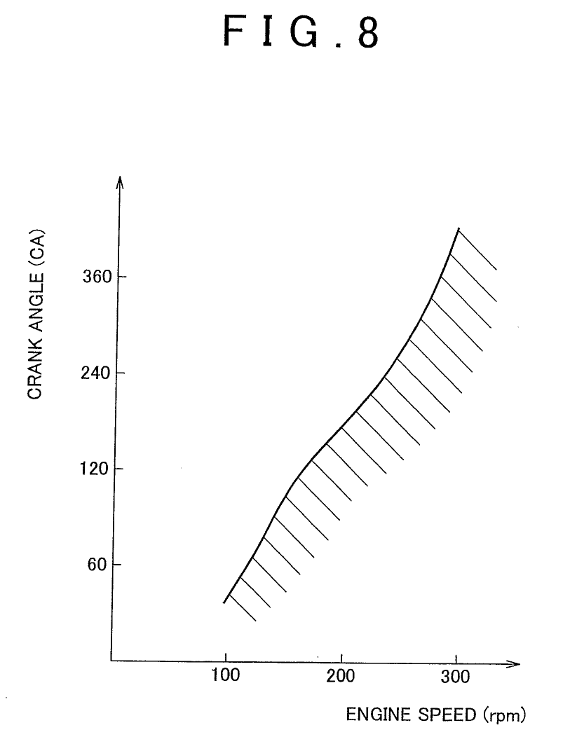

The determination as to whether the compression-stroke cylinder can go beyond the compression top dead center after the engine restart conditions are met is made at the time when the engine restart conditions are met, based on, for example, a map as shown in FIG. 8.

In FIG. 8, the x axis indicates the engine speed sensed at the time when the engine restart conditions are met, and the y axis indicates the crank angle over which the crankshaft 25 of the engine is able to rotate after the engine restart conditions are met. As is understood from FIG. 8, if the engine speed is equal to or higher than about 200 rpm when the engine restart conditions are met, the crankshaft 25 is able to rotated by 180° CA or more after the meeting of the engine restart conditions, and it is therefore determined that the compression stroke cylinder can go beyond the compression top dead center after the engine restart conditions are met.

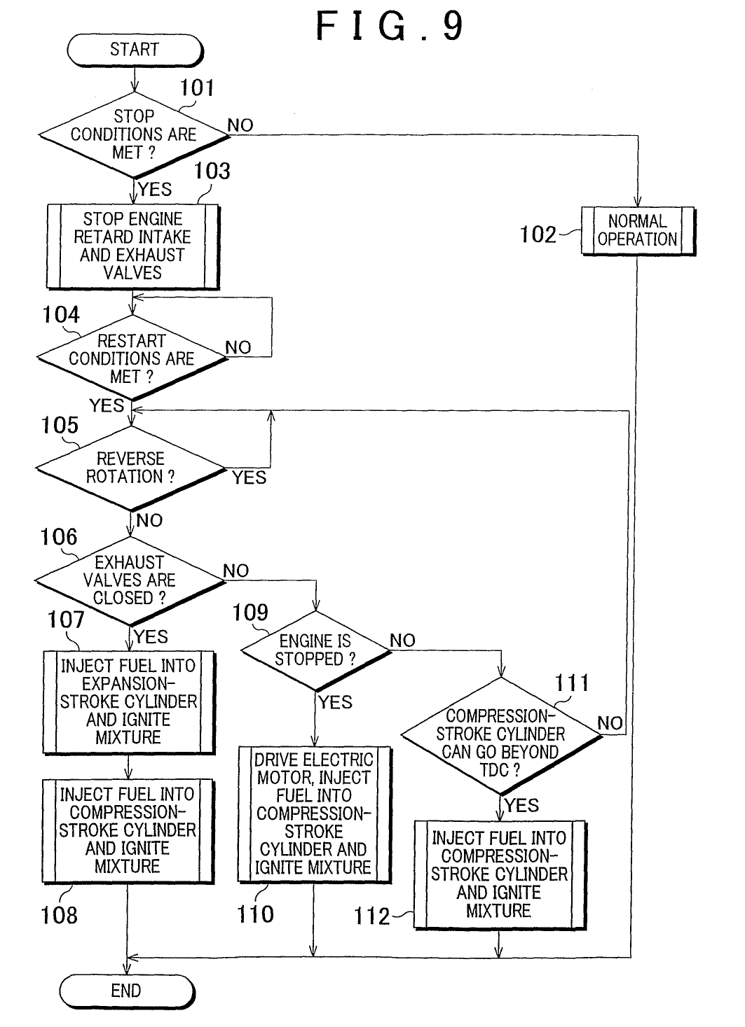

FIG. 9 is a flowchart showing a control routine of engine restart control performed by the starting system of the embodiment as described above. Initially, it is determined in step S101 whether the engine stop conditions are met, based on the outputs of, for example, the acceleration stroke sensor 41 and the crank angle sensor 28. If it is determined that the engine stop conditions are not met, the control proceeds to step S102 in which the normal operation of the engine is performed. If it is determined in step S101 that the engine stop conditions are met, the control proceeds to step S103.

In step S103, the engine is stopped, namely, the fuel injection from the fuel injection valves 21 and the ignition using the spark plugs 20 are stopped or inhibited, and the phase angles of the intake valves 17 and the exhaust valves 19 are retarded to the predetermined target phase angles as described above. In the following step S104, it is determined whether the engine restart conditions are met, based on the outputs of, for example, the acceleration stroke sensor 41 and the vehicle speed sensor. If it is determined that the engine restart conditions are not met, step S104 is repeatedly executed. If it is determined that the engine restart conditions are met, the control proceeds to step S105.

In step S105, it is determined whether the engine rotates in the reverse direction. If it is determined that the engine rotates in the reverse direction, step S105 is repeatedly executed, and execution of subsequent control is thus delayed. If it is determined that the engine does not rotate in the reverse direction, on the other hand, the control proceeds to step S106 in which it is determined whether the exhaust valves 19 of the expansion-stroke cylinder are closed. If it is determined in step S106 that the exhaust valves 19 are closed, the control proceeds to step S107 in which the fuel injection and ignition are performed in the expansion-stroke cylinder. In the following step S108, the fuel is injected into the compression-stroke cylinder, and the air-fuel mixture is ignited in the compression-stroke cylinder at the time when the compression-stroke cylinder reaches the compression top dead center or immediately after the same cylinder passes the compression top dead center.

If it is determined in step S106 that the exhaust valves 19 are open, on the other hand, the control proceeds to step S109 in which it is determined whether the rotation of the engine (or the rotation of the crankshaft 25) is stopped. If it is determined in step S109 that the rotation of the engine is stopped, the control proceeds to step S110. In step S110, the crankshaft 25 is driven by the electric motor 26, while the fuel is injected into the compression-stroke cylinder, and the mixture is ignited in the compression-stroke cylinder at the time when or immediately after the compression-stroke cylinder passes the compression top dead center.

If it is determined in step S109 that the rotation of the engine is not stopped, on the other hand, the control proceeds to step S111. In step S111, it is determined based on the map as shown in FIG. 8 whether the crankshaft 25 can rotate under the inertial force of the engine until the compression-stroke cylinder goes beyond the compression top dead center. If it is determined that the compression-stroke cylinder can go beyond the compression top dead center, the control proceeds to step S112 in which the fuel is injected into the compression-stroke cylinder, and the mixture is ignited in the compression-stroke cylinder at the time when or immediately after the compression-stroke cylinder passes the compression top dead center. If it is determined in step S111 that the compression-stroke cylinder cannot go beyond the compression top dead center, the control proceeds to step S105.

While the invention is applied to the four-cylinder internal combustion engine in the illustrated embodiment, the invention is not necessarily applied to the four-cylinder engine, but may also be applied to any other type of engine, such as a six-cylinder engine or an eight-cylinder engine, provided that the engine has four or more cylinders.

1. A starting system of an internal combustion engine including a fuel injection valve that directly injects a fuel into a cylinder and a spark plug that ignites an air-fuel mixture in the cylinder comprising:
a start controller that stops injection of the fuel from the fuel injection valve and ignition performed by the spark plug when an engine stop condition is met, wherein:
the start controller, when an engine restart condition is met during rotation of the engine after the engine stop condition is met, carries out the injection of the fuel from the fuel injection valve into an expansion-stroke cylinder that is in an expansion stroke at the time when the engine restart condition is met, and carries out the ignition of the air-fuel mixture formed in the expansion-stroke cylinder by the spark plug.

2. A starting system as defined in claim 1, wherein, the start controller, even when the engine restart condition is met during rotation of the engine after the engine stop condition is met, does not carry out at least the ignition of the air-fuel mixture in the expansion-stroke cylinder if the engine rotates in the reverse direction at the time when the engine restart condition is met.

3. A starting system as defined in claim 1, wherein, the start controller, when the engine restart condition is met during rotation of the engine after the engine stop condition is met, carries out the injection of the fuel during a compression stroke into a compression-stroke cylinder that is in the compression stroke at the time when the engine restart condition is met, in addition to the injection of the fuel into the expansion-stroke cylinder and the ignition of the air-fuel mixture in the expansion-stroke cylinder.

4. A starting system as defined in claim 3, wherein the start controller, after the fuel is injected into the compression-stroke cylinder during the compression stroke, carries out the ignition of the air-fuel mixture formed in the compression-stroke cylinder when the compression-stroke cylinder reaches a compression top dead center or after the compression-stroke cylinder passes the compression top dead center.

5. A starting system as defined in claim 1, wherein, the start controller, even when the engine restart condition is met during rotation of the engine after the engine stop condition is met, does not carry out the injection of the fuel into the expansion-stroke cylinder and the ignition of the air-fuel mixture in the expansion-stroke cylinder if an exhaust valve of the expansion-stroke cylinder is open at the time when the engine restart condition is met.

6. A starting system as defined in claim 1, wherein, the start controller carries out the injection of the fuel in normal timing into a cylinder that is in an intake stroke at the time when the engine restart condition is met and cylinders that subsequently enter the intake stroke.

7. A starting system as defined in claim 1, wherein, the start controller carries out the ignition of the air-fuel mixture in normal timing in a cylinder that is in an intake stroke at the time when the engine restart condition is met and cylinders that subsequently enter the intake stroke.

8. A starting system as defined in claim 1, wherein, the start controller, when the engine restart condition is met during rotation of the engine after the engine stop condition is met, retards at least the valve-opening timing of an exhaust valve of the expansion-stroke cylinder.

9. A starting system as defined in claim 1, wherein, the start controller, when the engine restart condition is met during rotation of the engine after the engine stop condition is met, retards at least the valve-closing timing of an intake valve of the compression-stroke cylinder.

10. A starting method of an internal combustion engine including a fuel injection valve that directly injects a fuel into a cylinder and a spark plug that ignites an air-fuel mixture in the cylinder, wherein, the starting method comprising:
stoping injection of the fuel from the fuel injection valve and ignition performed by the spark plug are stopped when an engine stop condition is met, and
injecting the fuel from the fuel injection valve into an expansion-stroke cylinder that is in an expansion stroke at the time when the engine restart condition is met, and igniting the air-fuel mixture formed in the expansion-stroke cylinder by the spark plug, when an engine restart condition is met during rotation of the engine after the engine stop condition is met.

11. A starting method as defined in claim 10, wherein even when the engine restart condition is met during rotation of the engine after the engine stop condition is met, at least the ignition of the air-fuel mixture in the expansion-stroke cylinder is not carried out if the engine rotates in the reverse direction at the time when the engine restart condition is met.

12. A starting method as defined in claim 10, further comprising:
injecting the fuel, when the engine restart condition is met during rotation of the engine after the engine stop condition is met, during a compression stroke into a compression-stroke cylinder that is in the compression stroke at the time when the engine restart condition is met, in addition to the injection of the fuel into the expansion-stroke cylinder and the ignition of the air-fuel mixture in the expansion-stroke cylinder.

13. A starting method as defined in claim 12, wherein after the fuel is injected into the compression-stroke cylinder during the compression stroke, the air-fuel mixture formed in the compression-stroke cylinder is ignited when the compression-stroke cylinder reaches a compression top dead center or after the compression-stroke cylinder passes the compression top dead center.

14. A starting method as defined in claim 10, wherein even when the engine restart condition is met during rotation of the engine after the engine stop condition is met, the injection of the fuel into the expansion-stroke cylinder and the ignition of the air-fuel mixture in the expansion-stroke cylinder are not carried out if an exhaust valve of the expansion-stroke cylinder is open at the time when the engine restart condition is met.

15. A starting method as defined in claim 10, further comprising:
injecting the fuel in normal timing into a cylinder that is in an intake stroke at the time when the engine restart condition is met and cylinders that subsequently enter the intake stroke.

16. A starting method as defined in claim 10, further comprising:
igniting the air-fuel mixture in normal timing in a cylinder that is in an intake stroke at the time when the engine restart condition is met and cylinders that subsequently enter the intake stroke.

17. A starting method as defined in claim 10 further comprising:
retarding at least the valve-opening timing of an exhaust valve of the expansion-stroke cylinder, when the engine restart condition is met during rotation of the engine after the engine stop condition is met.

18. A starting system as defined in claim 10, further comprising:
retarding at least the valve-closing timing of an intake valve of the compression-stroke cylinder, when the engine restart condition is met during rotation of the engine after the engine stop condition is met.
